(19) United States
(12) Patent Application Publication
(10) Pub. No.: US 2008/0239050 A1
(43) Pub. Date: Oct. 2, 2008

(54) INKJET RECORDING APPARATUS

(75) Inventor: Tadanobu Chikamoto, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/056,118

(22) Filed: Mar. 26, 2008

(30) Foreign Application Priority Data
Mar. 28, 2007 (JP) 2007083625

(51) Int. Cl. B41J 2/01

(52) U.S. Cl. 347/104

(57) ABSTRACT

An inkjet recording apparatus of the present invention includes: a plurality of inkjet heads each including an ink ejection surface and a plurality of nozzles formed within a predetermined area of the ink ejection surface; a pair of belt rollers; and a conveyor belt whose size in an axial direction of rotational shafts of the belt rollers is shorter than the predetermined area, which belt is looped around the pair of belt rollers. A plurality of supporting members whose respective positions in the axial direction are different from that of the conveyor belt, the supporting members being positioned apart from each other in a conveyance direction orthogonal to the axial direction so as to face the ink ejection surface and support both ends of the recording medium in the axial direction, which medium is longer than the conveyor belt in the axial direction.

### CROSS REFERENCE TO RELATED APPLICATION

The present application claims priority from Japanese Patent Application No. 2007-083625, which was filed on Mar. 28, 2007, the disclosure of which is herein incorporated by reference in its entirety.

### BACKGROUND OF THE INVENTION

1. Field of the Invention

The present invention relates to an inkjet recording apparatus having inkjet heads ejecting ink.

2. Description of Related Art

Japanese Unexamined Patent Publication No. 264174/2006 (Tokukai 2006-264174) describes an inkjet printer having an absorber and a blade which are for cleaning the external surface of a conveyor belt, which surface having ink adhered thereto at the time of marginless printing. In this inkjet printer, a cleaning liquid is supplied to the absorber contacting the external surface of the conveyor belt, thereby applying the cleaning liquid to the external surface of the conveyor belt. The ink having adhered to the external surface is mixed with the cleaning liquid on the external surface of the conveyor belt, and the mixture of the cleaning liquid and ink is scraped by the blade contacting the external surface of the conveyor belt. Thus, the ink having adhered on the external surface of the conveyor belt is removed.

### SUMMARY OF THE INVENTION

However, in the inkjet printer described in the above publication four inkjet heads ejecting ink of different colors ejects ink, so as to perform the marginless printing. Therefore, the ink having adhered onto the external surface of the conveyor belt is a mix of different colors.

Depending on the components contained in ink, the ink can be either pigment ink or dye ink. To remove ink which is a mixture of the pigment ink and the dye ink, a cleaning liquid capable of removing the both needs to be selected. With a cleaning liquid capable of mainly removing pigment ink, there will be a large amount of residual dye ink. On the contrary, with a cleaning liquid capable of mainly removing dye ink, there will be a large amount of residual pigment ink.

However, with a cleaning liquid for removing a mixture of the pigment ink and dye ink, the cleaning effect in relation the pigment ink is not as good as a case of removing the pigment ink with the cleaning liquid for removing the pigment ink, and the cleaning effect in relation the dye ink is not as good as a case of removing the dye ink with the cleaning liquid for removing the dye ink. Thus, there are significant difficulties in selecting appropriate cleaning liquid, and in cleanly removing adhered ink from the external surface.

An object of the present invention is to provide an inkjet recording apparatus which allows easy selecting of a cleaning liquid and easy removal of adhered ink.

From a first view point, there is provided an inkjet recording apparatus including: a plurality of inkjet heads; a pair of belt rollers; an endless conveyor belt; a plurality of supporting members; a rotation mechanism; an applying unit; and a removing unit. the plurality of inkjet heads eject from their nozzles different colors of ink towards a recording medium. Each of the inkjet heads includes an ink ejection surface, and the nozzles of each of the inkjet heads are formed within a predetermined area of the ink ejection surface. The pair of belt rollers are parallel to the ejection surface and respectively have rotational shafts parallel to each other. The conveyor belt whose size in an axial direction of the rotational shafts is shorter than that of the predetermined area, is looped around the pair of belt rollers, and transfers the recording medium, while supporting it by an external surface thereof, in a conveyance direction orthogonal to the axial direction. The plurality of supporting members are respectively positioned in positions that are (i) apart from each other in the conveyance direction and (ii) different from the position of the conveyor belt in the axial direction, so as to face the ink ejection surface and support both ends of the recording medium in the axial direction, the recording medium being longer than the conveyor belt in the axial direction. The rotation mechanism rotates the supporting members so as to feed the recording medium supported by the supporting members in the conveyance direction in cooperation with the conveyance by the conveyor belt. The applying unit applies a cleaning liquid on external surfaces of the supporting members. The removing unit, with the rotation of the supporting members, removes the cleaning liquid and the ink adhered on the external surfaces of the supporting member.

According to the view point, ink which is ejected from the nozzles of the inkjet heads facing the supporting member and which did not land on the recording medium adheres to the supporting members, during marginless printing. In short, each of the supporting members will only have one color of ink adhered thereto every time marginless printing is performed. As such, there will be no mixing of different colors of ink. Therefore, it is easy to select a cleaning liquid for removing the adhered ink from the supporting member, and remove the adhered ink from the supporting member.

### BRIEF DESCRIPTION OF THE DRAWINGS

Other and further objects, features and advantages of the invention will appear more fully from the following description taken in connection with the accompanying drawings in which:

FIG. 1 is a cross sectional side view schematically showing an inkjet printer of an Embodiment 1 according to the present invention.

FIG. 2 is a plane view of the belt transfer mechanism shown in FIG. 1.

FIG. 3 is a plane view of four inkjet heads shown in FIG. 1, viewed from the bottom.

FIG. 4 is a cross sectional side view schematically showing an inkjet printer of Embodiment 2 according to the present invention.

FIG. 5 is a plane view of the belt transfer mechanism shown in FIG. 4.

FIG. 6 is a cross sectional side view schematically showing an inkjet printer of Embodiment 3 according to the present invention.

FIG. 7 is a plane view of the belt transfer mechanism shown in FIG. 6.

### DESCRIPTION OF THE PREFERRED EMBODIMENTS

The following describes a preferable embodiment of the present invention.

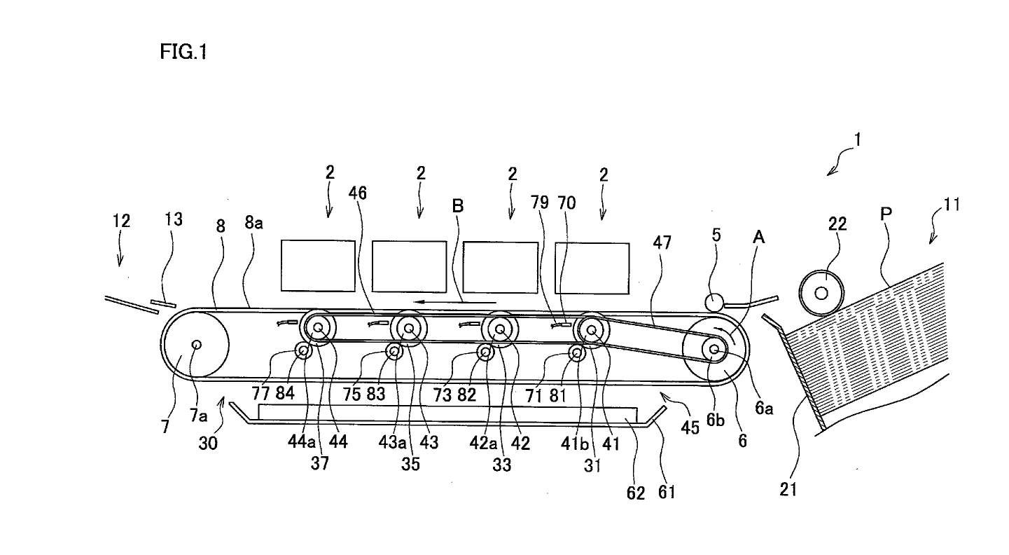

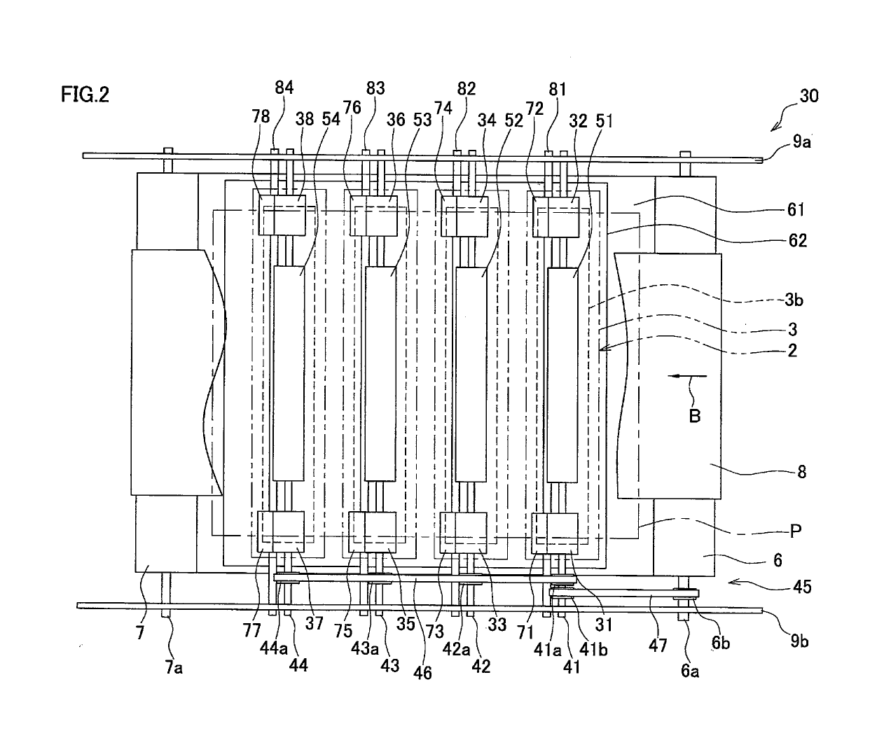

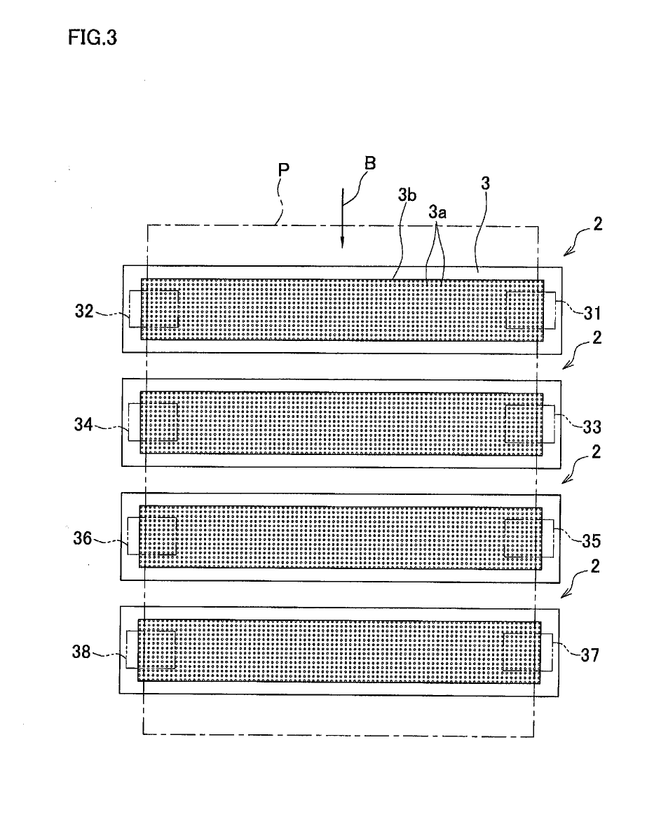

FIG. 1 is a cross sectional side view schematically showing an inkjet printer of Embodiment 1 according to the present invention. FIG. 2 is a plane view of the belt transfer mechanism shown in FIG. 1. FIG. 3 is a plane view of four inkjet heads shown in FIG. 1, viewed from the bottom.

As shown in FIG. 1, an inkjet printer 1 of the present embodiment which is an inkjet recording apparatus is a color inkjet printer having four inkjet heads 2. The inkjet printer 1 has such a structure that a sheet feeding mechanism 11 is disposed rightward of FIG. 1, and a sheet delivering mechanism 12 is disposed leftward of FIG. 1. Then, between the sheet feeding mechanism 11 and the sheet delivering mechanism 12, a belt transfer mechanism 30 is provided. Inside the inkjet printer 1, a sheet transfer path is formed. Through this transfer path, a sheet P which is a recording medium is transferred in a conveyance direction B (Direction of arrow B in FIG. 1) from the sheet feeding mechanism 11 towards the sheet delivering mechanism 12.

The sheet feeding mechanism 11 is provided with a pick up roller 22 which feeds a sheet P on top of sheets stored in a sheet tray 21. With this pick up roller 22, the sheet P is fed from right to left of FIG. 1.

As shown in FIG. 1, the belt transfer mechanism 30 includes: a pair of belt rollers 6, 7; and an endless conveyor belt 8 wound around the both rollers 6, 7 so as to bridge the rollers 6, 7. The belt rollers 6, 7 respectively have rotational shafts 6a, 7a, each of which shafts extended orthogonally to the conveyance direction. As shown in FIG. 2, the rotational shafts 6a, 7a are rotatably supported by frames 9a, 9b each extended in the conveyance direction B. Note that the direction in which the rotational shafts 6a, 7a are extended is hereinafter referred to as “axial direction”.

The conveyor belt 8 has a two layered structure including a base substrate, and polyurethane rubber disposed on the surface of the base substrate. The external surface 8a of the polyurethane rubber has adhesiveness. A pressing roller 5 is positioned so that the conveyor belt 8 is interposed between the roller 5 and the belt roller 6. The pressing roller 5 holds down the sheet P fed by the sheet feeding mechanism 11 against the conveyor belt 8.

Thus, the sheet P held down against the external surface 8a is retained on the external surface 8a by the adhesiveness of the external surface 8a, and is transferred in the conveyance direction B. At this point, the rotational shaft 6a of the belt roller 6 is rotated counter-clockwise (in the direction of arrow A) in FIG. 1, by a driving force given by a not-shown driving motor.

Between the conveyor belt 8 and the sheet delivering mechanism 12, a peeling member 13 is provided. The peeling member 13 is structured so as to peel the sheet P retained on the external surface 8a of the conveyor belt 8, and feed the sheet P leftward, towards the sheet delivering mechanism 12.

The four inkjet heads 2 respectively correspond to ink of four colors: Magenta, Yellow, Cyan, and Black. These four inkjet heads 2 are disposed and fixed so as to be aligned in the conveyance direction B. In short, the inkjet printer 1 is a line printer. Each of the inkjet heads 2 is formed in a rectangular parallelepiped shape whose longitudinal direction is elongated orthogonally to the conveyance direction B.

As shown in FIG. 3, on the respective bottom surfaces of the inkjet heads 2: i.e., ink ejection surfaces 3, a plurality of nozzles 3a for ejecting ink are formed. The plurality of nozzles 3a are formed within a nozzle formation region 3b which is a predetermined area of the ink ejection surface 3. The nozzle formation region 3b has a rectangular shape which is longer in the axial direction. The size of the nozzle formation region 3b in the longitudinal direction is longer than the size of the sheet P in the axial direction, the sheet P indicated by a chain line on FIG. 3. Further, the both ends of the nozzle formation region 3b in the longitudinal direction are positioned so as not to face the sheet P. That way, marginless printing can be performed with respect to the sheet P, even if the sheet P shifts in the axial direction.

Further, in addition the belt roller 6, 7 and the conveyor belt 8, the belt transfer mechanism 30 includes eight supporting rollers 31 to 38 serving as supporting members and four rollers 51 to 54 serving as belt supporting rollers, as shown in FIG. 2. The supporting rollers 31 to 38 and the rollers 51 to 54 are all disposed between the pair of belt roller 6, 7. The eight supporting rollers 31 to 38 are fixed on the four rotational shafts 41 to 44. The rotational shafts 41 to 44 are parallel to each other, and are extended in the axial direction. On these rotational shafts 41 to 44, the eight supporting rollers 31 to 38 are fixed so that each of the four rotational shafts 41 to 44 has two of the eight supporting rollers 31 to 38.

Specifically, the supporting rollers 31, 32 are fixed on the rotational shaft 41; the supporting rollers 33, 34 are on the rotational shaft 42; the supporting rollers 35, 36 are on the rotational shaft 43; and the supporting rollers 37, 38 are on the rotational shaft 44. In short, the supporting rollers sharing the same rotational shaft are disposed so that their positions in the conveyance direction B are the same. Note that the four rotational shafts 41 to 44 are all rotatably supported by the frames 9a, 9b.

The four rotational shafts 41 to 44 are disposed so as to face the inkjet heads 2. More specifically, each of the four rotational shafts 41 to 44 is disposed in a position that overlaps, in an up/down direction, a center line of the ink ejection surface 3 and the nozzle formation region 3b. Note that the center line is a line which extends along the axial direction in the middle of the ink ejection surface 3 and the nozzle formation region 3b which are respectively indicated by the double-dashed chain line and the dotted line of FIG. 2. Note further that “the up/down direction” is a direction perpendicular to the surface of the figure.

The four supporting rollers 31, 33, 35, and 37 are respectively disposed in positions that are different from the position of the conveyor belt 8 in the axial direction so as to face one ends (lower ends on FIG. 2), of the nozzle formation regions 3b of the four inkjet heads 2 in the longitudinal direction, from the up/down direction. On the other hand, the four supporting rollers 32, 34, 36, and 38 are respectively disposed in positions that are different from the position of the conveyor belt 8 in the axial direction so as to face the other ends (upper ends on FIG. 2), of the nozzle formation regions 3b of the four inkjet heads 2 in the longitudinal direction, from the up/down direction.

The eight supporting rollers 31 to 38 are capable of partially supporting the sheet P, indicated by the chain line of FIG. 2, which is retained by the conveyor belt 8. More specifically, the eight supporting rollers 31 to 38 are capable of partially supporting the both ends of the sheet P in the axial direction, at the back surface of the sheet P. In other words, the eight supporting rollers 31 to 38 are respectively disposed in positions that are (i) apart from each other in the conveyance direction and (ii) different from the position of the conveyor belt 8 in the axial direction so as to respectively face the ink ejection surfaces 3 and support the both ends of the sheet P in the axial direction, which sheet having a wider width than that of the conveyor belt 8. Further, as shown in FIG. 2 and FIG. 3, the respective diameters of the eight supporting rollers 31 to 38 are all the same, and are shorter than the size of the nozzle formation region 3b in the conveyance direction B.

Further, the four rollers 51 to 54 are fixed one by one between supporting rollers respectively fixed on the rotational shafts 41 to 44, and support a part of the conveyor belt 8 facing the ink ejection surface 3, from the back surface of the conveyor belt 8. In short, the four rollers 51 to 54 constitutes a roller platen supporting the conveyor belt 8. That way, it is possible to reduce curvature in a part of the conveyor belt 8 whereby the sheet P is retained; i.e., a part facing the inkjet head 2, and therefore the distance between the sheet P and the nozzle formation region 3b can be kept substantially constant. This improves the landing accuracy of ink; i.e., the printing accuracy.

Note that all of the four rollers 51 to 54 also have the same diameter. The respective diameters of the rollers 51 to 54 are slightly smaller than those of the supporting rollers 31 to 38.

The belt transfer mechanism 30 is provided with a rotation mechanism 45 which causes rotation of the supporting rollers 31 to 38 with transferring of the sheet P. The rotation mechanism 45 includes six rollers 6b, 41a, 41b, 42a to 44a, and two endless timing belt 46, 47 each serving as transmission. The four rollers 41a to 44a are respectively fixed nearby one ends (lower ends of FIG. 2) of the rotational shafts 41 to 44 so as to be rotatable along with the rotational shafts 41 to 44. The timing belt 46 are looped around the four rollers 41a to 44a so as to equally transmit the rotational force to the four rollers 41a to 44a.

The roller 41b is rotatably fixed, along with the rotational shaft 41, between the roller 41a of the rotational shaft 41 and the frame 9b. Further, the roller 6b is rotatably fixed, along with the rotational shaft 6a, nearby an end (lower end of FIG. 2) of the rotational shaft 6a of the belt roller 6. The timing belt 47 is looped around the rollers 6b, 41b so as to transmit the same rotational force to the two rollers 6b, 41b.

With the structure of the rotation mechanism 45, the timing belt 47 looped around the rollers 6b and 41b runs when the rotational shaft 6a is driven by the not-shown driving motor, and rotates in the direction of arrow A of FIG. 1. The rotational force of the rotational shaft 6a is transmitted to the rotational shaft 41, thereby rotating the rotational shaft 41 in the same direction as the rotational shaft 6a. This rotation of the rotational shaft 41 runs the timing belt 47 looped around the rollers 41a to 44a. The rotational force of the rotational shaft 6a is further transmitted to the rotational shafts 42 to 44, thereby rotating the rotational shafts 42 to 44 in the same direction as the rotational shaft 6a. In sum, the belt roller 6 is driven and rotated, causing the conveyor belt 8 to run. The running of the conveyor belt 8 causes the rotation of the eight supporting rollers 31 to 38 respectively fixed on the rotational shafts 42 to 44. In other words, the sheet P retained by the conveyor belt 8 is transferred from the sheet feeding mechanism 11 to the sheet delivering mechanism 12, while the ends of the sheet P in the axial direction sticking out from the both ends of the conveyor belt 8 are supported by the rotating supporting rollers 31 to 38.

As shown in FIG. 1, a tray 61 and an ink receiver 62 provided on the tray 61 are disposed below the belt transfer mechanism 30. In the present embodiment, the ink receiver 62 is made of sponge having flexibility and interconnected cells. Further, as shown in FIG. 2, the ink receiver 62 is formed in a shape of substantially rectangular in plane view which extends overall the four ink ejection surface 3. As hereinbelow detailed, the ink receiver 62 is capable of receiving ink which was not received by the supporting rollers 31 to 38. Further, the tray 61 is slightly larger than the ink receiver 62, and is in the shape of rectangular in plane view. This tray 61 retains the entire ink receiver 62.

As shown in FIG. 1 and FIG. 2, the printer 1 is provided with eight cleaning nozzles 70 serving as applying means, and eight cleaning rollers 71 to 78 serving as the removing means. The cleaning nozzle 70 is for ejecting a cleaning liquid thereby applying the cleaning liquid to the external surface of each of the supporting rollers 31 to 38. The cleaning rollers 71 to 78 respectively abut the external surfaces of the supporting rollers 31 to 38. Note that FIG. 1 only illustrates four cleaning nozzles 70. However, in each position where those four cleaning nozzles 70 are shown, two cleaning nozzles 70 are aligned in the perpendicular direction the surface of the figure. For the sake of simplifying the explanation, the eight cleaning nozzles 70 are omitted in FIG. 2.

The cleaning nozzle 70 is capable of ejecting the cleaning liquid towards the entire width of the supporting rollers 31 to 38 in the axial direction. To the cleaning nozzle 70, the cleaning liquid fed from a not-shown cleaning liquid tank is supplied via a tube 79. Note that the inkjet printer 1 of the present embodiment is provided with four cleaning liquid tanks, each supplies a cleaning liquid to two of the supporting rollers 31 to 38 fixed on the associated one of the rotational shafts 41 to 44.

The cleaning rollers 71 to 78 are fixed on four rotational shafts 81 to 84. The rotational shafts 81 to 84 are parallel to each other, and are extended in the axial direction. On these rotational shafts 81 to 84, the cleaning rollers 71 to 78 are fixed so that each of the four rotational shafts 81 to 84 has two of the supporting rollers 71 to 78. Specifically, the cleaning rollers 71, 72 are fixed on the rotational shaft 81; the cleaning rollers 73, 74 are on the rotational shaft 82; the cleaning rollers 75, 76 are on the rotational shaft 83; and the cleaning rollers 77, 78 are on the rotational shaft 84. Note that the four rotational shafts 81 to 84 are also rotatably supported on the frames 9a, 9b.

Further, the cleaning rollers 71 to 78 of the present embodiment is made of sponge having flexibility and interconnected cells. The respective sizes of the cleaning rollers 71 to 78 in the axial direction are substantially the same as those of the supporting rollers 31 to 38, respectively. The four cleaning rollers 71, 73, 75, 77 respectively abut the external surfaces of the supporting rollers 31, 33, 35, 37, and the cleaning rollers 72, 74, 76, 78 respectively abut the external surfaces of the supporting rollers 32, 34, 36, 38. The eight cleaning rollers 71 to 78 rotate with friction generated by the rotation of the supporting rollers 31 to 38. The rotational directions of the cleaning rollers 71 to 78 are opposite to those of the supporting rollers 31 to 38. Thus, the cleaning rollers 71 to 78 abut the entire external surface of the supporting rollers 31 to 38, thereby absorbing and removing the cleaning liquid and the ink adhered on the external surface of the supporting rollers 31 to 38.

Next described is an operation performed in the inkjet printer 1, at the time of marginless printing to the sheet P. In the marginless printing performed by the inkjet printer 1 of the present embodiment, a sheet P to be subject to the marginless printing is wider than the conveyor belt 8. First, the sheet P is fed out from the sheet feeding mechanism 11 in such a manner that the sheet P is retained by the conveyor belt 8 with its both ends in the axial direction sticking out from the conveyor belt 8.

Next, the not-shown driving motor is driven to rotate the rotational shaft 6a, thereby rotating the pair of belt rollers 6, 7 and the conveyor belt 8. At this point, the eight supporting rollers 31 to 38 are also rotated in the same direction by the rotation mechanism 45. Thus, in the belt transfer mechanism 3, the middle part of the sheet P is retained by the conveyor belt 8, and the both ends of the sheet P in the axial direction are successively supported by the supporting rollers 31 to 38, while the sheet P is transferred towards the sheet delivering mechanism 12.

Next, the inkjet heads 2 facing the sheet P successively eject ink. At this point, as shown in FIG. 2, and FIG. 3, ink from the nozzles 3a which do not face the sheet P adheres to regions of the external surfaces of the eight supporting rollers 31 to 38 which regions do not face the sheet P. Further, at this point, the ink which did not land on the sheet P or adhered to the supporting rollers 31 to 38 lands on the ink receiver 62 and is absorbed therein. Thus, with the provision of the ink receiver 62, it is possible to receive the ink which did not adhered onto the external surfaces of the supporting rollers 31 to 38. This keeps the inside of the inkjet printer 1 from being tainted.

To clean the external surface of the supporting rollers 31 to 38 having ink adhered thereto, the cleaning liquid is ejected from the cleaning nozzles 70 to the external surface of the supporting rollers 31 to 38. Then, the cleaning rollers 71 to 78 which rotate with the supporting rollers 31 to 38 absorbs and removes the cleaning liquid and the ink adhered on the external surfaces of the supporting rollers 31 to 38. Thus, it is possible to prevent the ink on the supporting rollers 31 to 38 from tainting the sheet P, when the ink makes a round trip and once again comes in the position support a sheet P.

After the inkjet heads 2 eject the ink thereby performing the marginless printing to an entire printing surface of the sheet P, the sheet P is peeled from the conveyor belt 8 with an aide of the peeling member 13, and is fed to the sheet delivering mechanism 12. Thus, the marginless printing is completed.

During the marginless printing performed by the inkjet printer 1 of the Embodiment 1, the ink ejected from the nozzles of the inkjet heads facing the supporting rollers, which ink did not land on the sheet P, is adhered on the respective external surfaces of the supporting rollers 31 to 38. In other words, the ink adhered to the supporting rollers 31 to 38 is ink of a single color ejected from a single inkjet head, and therefore has an identical component. As such, there is no ink of a different color mixed in. It is therefore easy to select a cleaning liquid for removing the adhered ink from the external surface of the supporting rollers 31 to 38. In other words, since the ink which could adhere to the supporting rollers 31 to 38 is predictable, a most suitable cleaning liquid can be selected according to the prediction. Further, the use of a most suitable cleaning liquid allows easier removal of the adhered ink.

Further, the eight supporting rollers 31 to 38 are fixed so that each of the rotational shafts 41 to 44 has thereon two of the supporting rollers 31 to 38. The configuration of the rotation mechanism 45 is simplified. Further, since the rotation mechanism 45 has two timing belts 46, 47, it is therefore not necessary to separately provide driving means such as a driving motor for driving the rotational mechanism 45. In other words, the conveyor belt 8 is run while the eight supporting rollers 31 to 38 are rotated, all with an aide of a single driving motor.

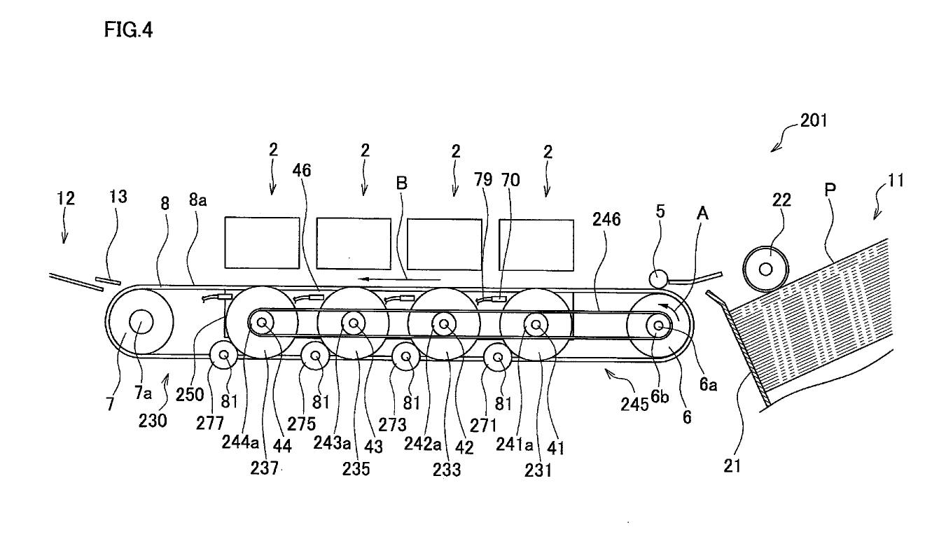

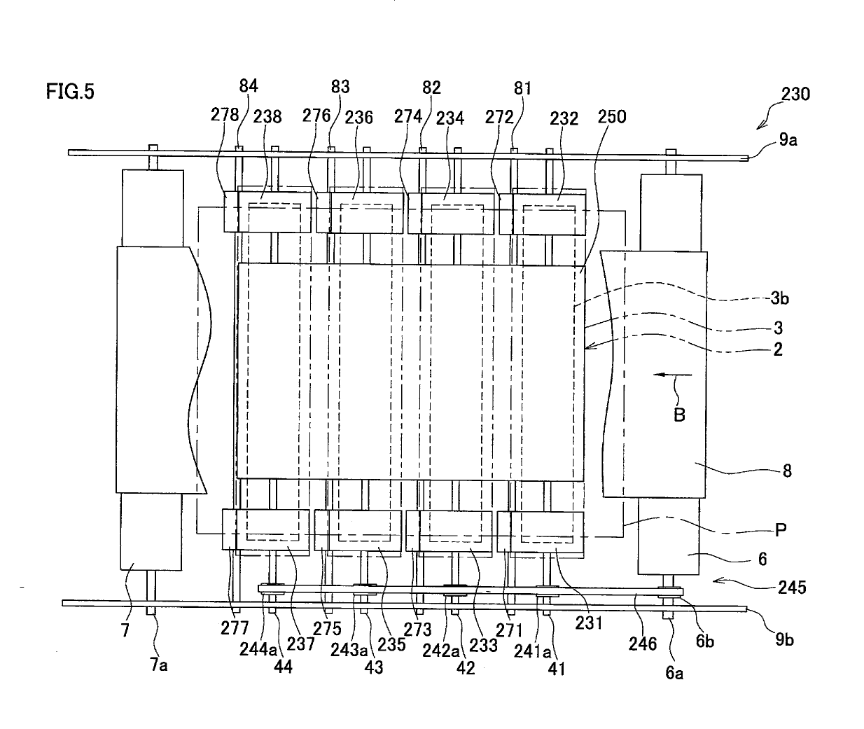

Next, the following describes an inkjet printer 201 of Embodiment 2, with reference to FIG. 4 and FIG. 5. FIG. 4 is a cross sectional side view schematically showing an inkjet printer 201 of the Embodiment 2 according to the present invention. FIG. 5 is a plane view of a belt transfer mechanism shown in FIG. 4. The same symbols are given to members that are identical to those described in the foregoing Embodiment 1, and no further description of those members are provided here.

The inkjet printer 201 of the present embodiment is substantially the same as the inkjet printer 1 of Embodiment 1, except in that the inkjet printer 201 includes: a belt transfer mechanism 230 whose structure is slightly different from that of the belt transfer mechanism 30 of the Embodiment 1. The belt transfer mechanism 230 includes: eight supporting rollers 231 to 238 that are slightly different from those of the Embodiment 1. The eight supporting rollers 231 to 238 are fixed on four rotational shafts 41 to 44 similar to those of the Embodiment 1, so that each of the four rotational shafts 41 to 44 has two of the supporting rollers 231 to 238.

Specifically, the supporting rollers 231, 232 are fixed on the rotational shaft 41; the supporting rollers 233, 234 are on the rotational shaft 42; the supporting rollers 235, 236 are on the rotational shaft 43; and the supporting rollers 237, 238 are on the rotational shaft 44. That is, as shown in FIG. 5, the supporting rollers disposed in positions that are the same in the conveyance direction B share one of the rotational shafts 41 to 44.

As is the case of Embodiment 1, the four supporting rollers 231, 233, 235, and 237 are respectively positioned in positions that are different from the position of the conveyor belt 8 in the axial direction so as to respectively face one ends (lower ends on FIG. 5), of the nozzle formation regions 3b of the four inkjet heads 2 in the longitudinal direction, from the up/down direction. On the other hand, the four supporting rollers 232, 234, 236, and 238 are respectively positioned in positions that are different from the position of the conveyor belt 8 in the axial direction so as to respectively face the other ends (upper ends on FIG. 5), of the nozzle formation regions 3b of the four inkjet heads 2 in the longitudinal direction, from the up/down direction.

The eight supporting rollers 231 to 238 are capable of partially supporting the sheet P indicated by the chain line of FIG. 5, which sheet is retained by the conveyor belt 8. More specifically, the eight supporting rollers 231 to 238 are capable of partially supporting the both ends of the sheet P in the axial direction, at the back surface of the sheet P. In other words, the eight supporting rollers 231 to 238 are disposed in positions that are (i) apart from each other in the conveyance direction and (ii) different from the position of the conveyor belt 8 in the axial direction, so as to face the corresponding one of the ink ejection surfaces 3 and support both ends of the sheet P in the axial direction, which sheet having a wider width than that of the conveyor belt 8.

Further, as shown in FIG. 4 and FIG. 5, the eight supporting rollers 231 to 238 each has the same diameter which is larger than any one of the diameters of the supporting rollers 31 to 38 of Embodiment 1 and which is substantially the same as the size of the ink ejection surface 3 in the conveyance direction B. That is, the diameters of the supporting rollers 231 to 238 are larger than the size of the nozzle formation region 3b in the conveyance direction B. Accordingly, each of the nozzle formation regions 3b is positioned so that both ends thereof in the axial direction entirely face the corresponding one of the supporting rollers 231 to 238. Therefore, the ink which did not land the sheet P during the marginless printing all adheres to the supporting rollers 231 to 238. Therefore, scattering of the ink inside the inkjet printer 201 is restrained and the inside of the inkjet printer 201 therefore is less likely to be tainted, even without the ink receiver 62 and the tray 61 as is required in Embodiment 1. Further, the ink adhered on the external surface of the supporting rollers 231 to 238 is ink of a single color ejected from a single inkjet head, and therefore has an identical component. As such, there is no ink of a different color mixed in. Thus, the similar effect to that of Embodiment 1 is resulted.

Further, a flat platen 250 is disposed between the pair of the belt rollers 6, 7, and between the supporting rollers on both ends of the rotational shafts 41 to 44. The top surface of the flat platen 250 abuts the back surface of the conveyor belt 8, thereby supporting a region of the conveyor belt 8 facing the inkjet heads 2. The flat platen 250 is in a shape of substantially rectangular parallelepiped as shown in FIG. 4 and FIG. 5. The rotational shafts 41 to 44 rotatably penetrate the flat platen 250 in the axial direction from one side surface to another side surface. The size of the top surface of the flat platen 250 in the conveyance direction B is longer than a length that extends over all the nozzle formation region 3b. Further, the size of the top surface of the flat platen 250 in the axial direction is slightly shorter than that of the conveyor belt 8 in the same direction.

With such a flat platen 250, the part of the conveyor belt 8 retaining the sheet P; i.e., the part facing the inkjet heads 2 is hardly curved. It is therefore possible to keep a constant distance between the sheet P and the nozzle formation regions 3b. That way, the landing accuracy of the ink; i.e., the printing accuracy is further improved.

As shown in FIG. 4 and FIG. 5, the belt transfer mechanism 230 includes a rotation mechanism 245 for rotating the supporting rollers 231 to 238 while the sheet P is transferred. The rotation mechanism 245 includes: five rollers 6b, and 241a to 244a; and an endless timing belt 246 serving as a transmission.

The five rollers 6b, and 241a to 244a are respectively disposed nearby one ends (lower ends of FIG. 5) of the rotational shafts 6a, and 41 to 44. Further, five rollers 6b and 241a to 244a are rotatably fixed along with the rotational shafts 6a, 41 to 44, respectively. Further, the timing belt 246 is looped around the rollers 6b, and 241a to 244 so as to transmit a rotational force to these rollers.

With the structure of the rotation mechanism 245, the timing belt 246 looped around the five rollers 6b, and 241a to 244a runs when the rotational shaft 6a of the belt roller 6 is rotated, by the driving of a not-shown driving motor, in the counter-clockwise direction (in the direction of arrow A) of FIG. 4. That way, the rotational force of the rotational shaft 6a is transmitted to the rotational shafts 41 to 44, and the rotational shafts 41 to 44 rotates in the same direction as the rotational shaft 6a. Thus, eight supporting rollers 231 to 238 also rotate as the conveyor belt 8 runs. In other words, the sheet P retained by the conveyor belt 8 is transferred from the sheet feeding mechanism 11 to the sheet delivering mechanism 12, while the ends of the sheet P in the axial direction sticking out from the both ends of the conveyor belt 8 are partially supported by the supporting rollers 231 to 238.

Note that the eight cleaning rollers 271 to 278 in the inkjet printer 201 of the present embodiment is the same as cleaning rollers 71 to 78 described in the foregoing Embodiment 1, except in that the diameters of the cleaning rollers 271 to 278 are slightly larger than those of the cleaning rollers 71 to 78, respectively. That is, the cleaning rollers 271 to 278 also rotates with the friction generated by the rotation of the supporting rollers 231 to 238, and are capable of absorbing and thereby removing a cleaning liquid and the ink adhered on the entire external surface of the supporting rollers 231 to 238.

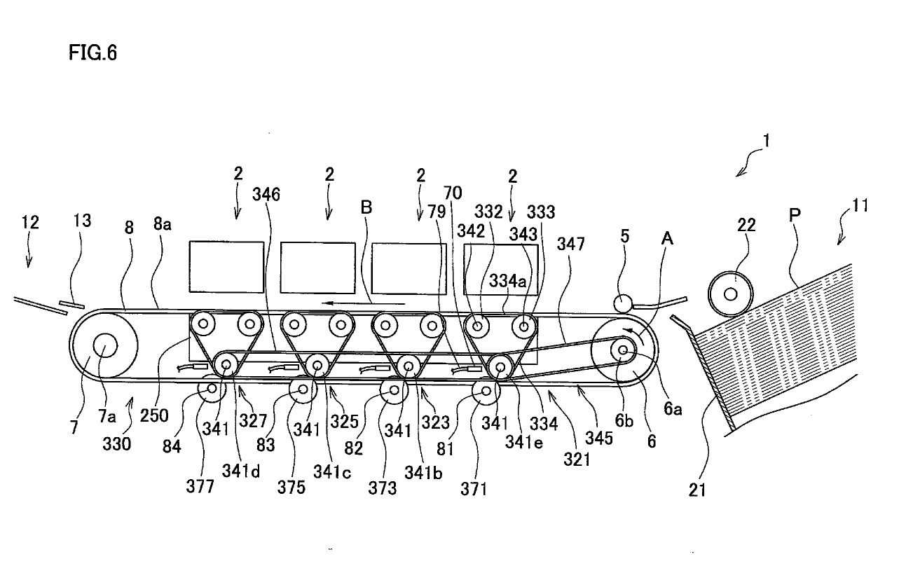

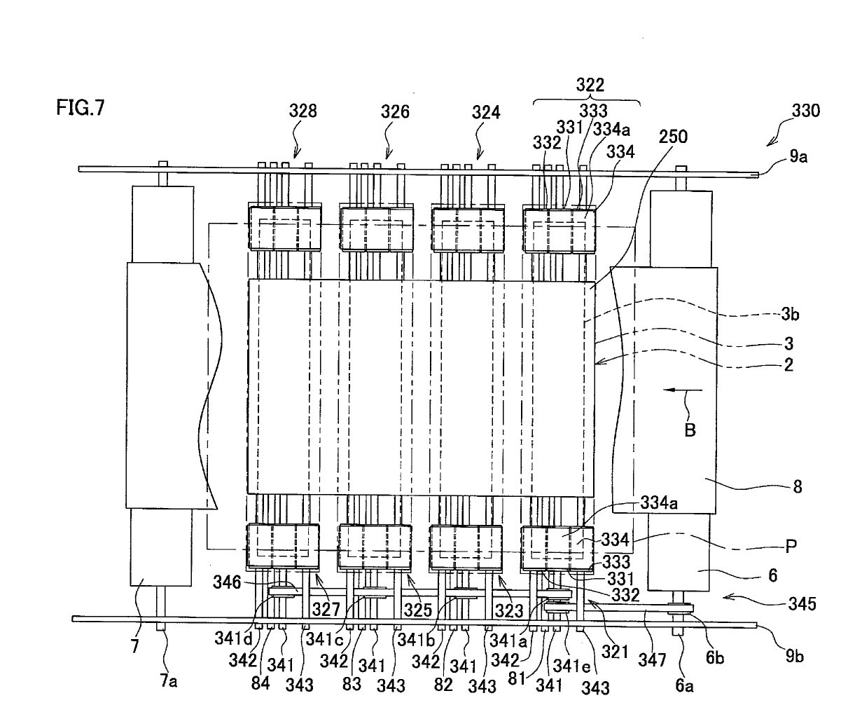

Next, the following describes an inkjet printer 301 of Embodiment 3, with reference to FIG. 6 and FIG. 7. FIG. 6 is a cross sectional side view schematically showing an inkjet printer 301 of an Embodiment 3 according to the present invention. FIG. 7 is a plane view of the belt transfer mechanism shown in FIG. 6. The same symbols are given to members that are identical to those described in the foregoing Embodiment 2, and no further explanation for those members are provided here.

The inkjet printer 301 of the present embodiment is the same as the inkjet printer 201 of Embodiment 2, except in that the inkjet printer 301 includes a belt transfer mechanism 330 whose structure slightly differ from the belt transfer mechanism 230 of Embodiment 2. The belt transfer mechanism 330 includes eight supporting mechanisms 321 to 328, instead of eight supporting rollers 231 to 238 of Embodiment 2.

Note that the respective structures of eight supporting mechanisms 321 to 328 are all the same, and therefore the following specifically describes the supporting mechanism 321. The supporting mechanism 321 includes: three auxiliary rollers 331 to 333; and a supporting belt 334 serving as a supporting member. The supporting belt 334 is an endless belt looped around the three auxiliary rollers 331 to 333. The three auxiliary rollers 331 to 333 are respectively fixed nearby one ends (lower ends of FIG. 7) of the three rotational shafts 341 to 343 which are extended in the axial direction and are disposed in parallel to one another. Note that the three rotational shafts 341 to 343 penetrate a flat platen 250 in the axial direction, and are rotatably supported on the frames 9a, 9b.

The respective diameters and the length in the axial direction of the three auxiliary rollers 331 to 333 are all the same. Further, of the three auxiliary rollers 331 to 333, the auxiliary roller 331 is disposed below the rest of two auxiliary rollers 332, 333, and the two auxiliary rollers 332, 333 are disposed at the same height. As described, disposing the auxiliary rollers 332, 333 at the same height forms a plane part 334a on the supporting belt 334, which part is parallel to the ink ejection surface 3.

The two auxiliary rollers 332, 333 are disposed apart from each other in the conveyance direction B so that the size of the plane part 334a in the conveyance direction B substantially equals that of the ink ejection surface 3. The auxiliary roller 331 is disposed sharply in the middle of the two auxiliary rollers 332, 333. The size of the supporting belt 334 in the axial direction equals to those of the three auxiliary rollers 331 to 333 in the same direction.

These three auxiliary rollers 331 to 333 of the supporting mechanism 322 having the similar structure to that of the supporting mechanism 321 are fixed nearby the other ends (upper ends in FIG. 7) of the three rotational shafts 341 to 343, where the supporting mechanism 321 is provided. Further, the supporting belt 334 is looped around the three auxiliary rollers 331 to 333 constituting the supporting mechanism 322. As is the case of the supporting mechanisms 321, 322, the supporting mechanisms 323, 324, the supporting mechanisms 325, 326, and the supporting mechanisms 327, 328 are respectively fixed, in these pairs, to three groups of rotational shafts each of which groups including three rotational shafts 341 to 343.

As described, the each of the supporting mechanisms 321 to 328 includes: the three kinds of auxiliary rollers 331 to 333, wherein the three kinds of auxiliary rollers 331 to 333 are fixed on both ends of the rotational shafts 341 to 343, respectively. Thus, the rotational shafts 341 to 343 are respectively shared with the associated rollers on the both ends, and the structure of the rotation mechanism 345 is simplified.

The respective plane parts 334a of the eight supporting mechanisms 321 to 328 are capable of partially supporting the sheet P indicated by the chain line of FIG. 7, which sheet is retained by the conveyor belt 8. More specifically, the plane parts 334a are capable of partially supporting the both ends of the sheet P in the axial direction, at the back surface of the sheet P. In other words, the plane parts 334a are respectively disposed in positions that are (i) apart from each other in the conveyance direction B, and (ii) different from the position of the conveyor belt 8 in the axial direction so as to respectively face the ink ejection surfaces 3 and support the both ends of the sheet P having a wider width than that of the conveyor belt 8.

Thus, in the present embodiment, the both ends of the nozzle formation region 3b in the axial direction face the entire length of a plane parts 334a of the eight supporting mechanisms 321 to 328 in the conveyance direction B. Accordingly, as is the case of the Embodiment 2, ink which did not land on the sheet P at the time of marginless printing adheres to the plane part 334a. As a result, the scattering of the ink inside the inkjet printer 201 is restrained, and the inside of the inkjet printer 301 therefore is less likely to be tainted, even without the ink receiver 62 and the tray 61 as is required in Embodiment 1. Further, the ink adhered on the plane parts 334a is ink of a single color ejected from a single inkjet head, and therefore has an identical component. As such, there is no ink of a different color mixed in. Thus, the similar effect to that of Embodiment 1 is resulted. Additionally, the both ends of the sheet Pin the axial direction can be stably supported with the formation of the plane parts 334a on the supporting belt 334.

The belt transfer mechanism 330 includes the rotation mechanism 345 which runs the supporting belts 334 associated with the eight supporting mechanisms 321 to 328 while the sheet P is transferred. The rotation mechanism 345 includes the six rollers 6b, 341a to 341e; and the two endless timing belt 346, 347 serving as the transmission.

The four rollers 341a to 341d are rotatably fixed, along with the corresponding rotational shafts 341, nearby one ends (lower ends of FIG. 7) of the rotational shafts of the corresponding supporting mechanisms, respectively. The timing belt 346 is looped around the four rollers 341a to 341d so as to transmit the same rotational force to the four rollers 341a to 341d.

The roller 341e is rotatably fixed on the corresponding one of the rotational shafts 341 so as to be rotatable along with the corresponding one of the rotational shafts 341. More specifically, the roller 341e is fixed between the frame 9b and the roller 341a of one of the rotational shafts 341 disposed in the closest position the belt roller 6. The timing belt 347 is looped around the roller 6b and the roller 341e so as to transmit the same rotational force to the two rollers.

With this rotation mechanism 345, the timing belt 347 runs when the rotational shaft 6a rotates in the counter-clockwise direction (direction of arrow A) of FIG. 6, in response to the driving of the not-shown driving motor. Thus, the rotational force of the rotational shaft 6a is transmitted to one of the rotational shafts 341 associated with the roller 341e, thereby rotating that one of the rotational shafts 341 in the same direction as the rotational shaft 6a. This rotation of that one of the rotational shafts 341 runs the timing belt 346 looped around the four rollers 341a to 341d, thus rotating the rest of the rotational shafts 341 in the same direction as the rotational shaft 6a. With the rotation of the rotational shafts 341, the auxiliary roller 331 fixed to that one of the rotational shafts 341 is rotated. This rotation of the auxiliary roller 331 runs the supporting belt 334 looped around the auxiliary roller 331, thereby rotating the other two auxiliary rollers 332, 333. Thus, the supporting belt 334 associated with each one of the eight supporting mechanism 321 to 328 runs in the conveyance direction B. In short, the sheet P retained by the conveyor belt 8 is transferred from the sheet feeding mechanism 11 to the sheet delivering mechanism 12, while the ends of the sheet P in the axial direction, which parts sticking out from the both ends of the conveyor belt 8, are partially supported by the plane part 334a of the rotating supporting belt 334.

Note that the eight cleaning rollers 371 to 378 provided in the inkjet printer 301 are the same as the cleaning rollers 71 to 78 of Embodiment 1, except in that the external surfaces of the cleaning rollers 371 to 378 abut the supporting belt 334, and that the diameters of the cleaning rollers 371 to 378 are slightly larger than those of the cleaning rollers 71 to 78. That is, the cleaning rollers 371 to 378 also rotates with the friction generated by the rotation of the supporting roller 334, and are capable of absorbing and thereby removing a cleaning liquid and the ink adhered on the entire external surface of the supporting belt 334.

The external surface of each of the conveyor belts 8 of the above embodiments 1 to 3 has adhesiveness. However, a sheet may be adsorbed to the external surface of a conveyor belt by means of electrically charging the conveyor belt. Further, it is also possible to perforate a plurality of holes through a conveyor belt in the thickness direction, and to have a sheet adsorbed to the external surface of the conveyor belt by means of suction through the plurality of holes.

Further, the inkjet printer 1 of Embodiment 1 does not necessarily have to include the ink receiver 62 and the tray 61.

Further, Embodiment 3 deals with a case where the supporting mechanisms 321 to 328 all includes three kinds of auxiliary rollers 331 to 333. However, the number of kinds of the auxiliary roller is not limited to three. For example, the number of kinds of the auxiliary rollers may be 2 or 4 or more. Additionally, the size of the plane part 334a of the supporting belt 334 in the conveyance direction B may be smaller than that of the nozzle formation region 3b. In this case, the ink receiver 62 of Embodiment 1 is preferably provided.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An inkjet recording apparatus comprising:
a plurality of inkjet heads which eject different colors of ink towards a recording medium, wherein each of the inkjet heads includes an ink ejection surface and nozzles for ejecting the ink formed within a predetermined area of the ink ejection surface;
a pair of belt rollers respectively having rotational shafts which are parallel to each other and are parallel to the ejection surface;
an endless conveyor belt whose size in an axial direction of the rotational shafts is shorter than that of the predetermined area, and which is looped around the pair of belt rollers and transfers the recording medium, while supporting it by an external surface thereof, in a conveyance direction orthogonal to the axial direction;
a plurality of supporting members respectively positioned in positions that are (i) apart from each other in the conveyance direction and (ii) different from the position of the conveyor belt in the axial direction, so as to face the ink ejection surface and support both ends of the recording medium in the axial direction, the recording medium being longer than the conveyor belt in the axial direction;
a rotation mechanism which rotates the supporting members so as to feed the recording medium supported by the supporting members in the conveyance direction in cooperation with the conveyance by the conveyor belt;
an applying unit which applies a cleaning liquid on external surfaces of the supporting members; and
a removing unit which, with the rotation of the supporting members, removes the cleaning liquid and the ink adhered on the external surfaces of the supporting member.

2. The apparatus according to claim 1, further comprising:
a ink receiver for receiving the ink,
wherein each of the supporting members includes a supporting roller having a diameter which is smaller than the width of the predetermined area in the conveyance direction, and a rotational shaft of which is parallel to the axial direction; and
the ink receiver is provided so that supporting rollers are positioned between ink receiver and the inkjet head.

3. The apparatus according to claim 2, wherein:
a pair of the supporting rollers, whose positions in the conveyance direction are the same, share a common rotational shaft.

4. The apparatus according to claim 1, wherein:
each of the supporting members includes a supporting roller having a diameter which is not less than the width of the predetermined area in the conveyance direction, and a rotational shaft of which is parallel to the axial direction.

5. The apparatus according to claim 4, wherein:
a pair of the supporting rollers, whose positions in the conveyance direction are the same, share a common rotational shaft.

6. The apparatus according to claim 1, wherein:
each of the supporting members is an endless supporting belt looped around two or more auxiliary rollers respectively having rotational shafts extended in the axial direction; and
two auxiliary rollers out of the two or more auxiliary rollers are positioned apart from each other in the conveyance direction so that the supporting belt has a plane part which is parallel to the ink ejection surface.

7. The apparatus according to claim 6, wherein:
the width of the plane part in the conveyance direction is not less than a width of the predetermined area.

8. The apparatus according to claim 6, wherein:
a pair of the auxiliary rollers out of the two or more auxiliary rollers, whose positions in the conveyance direction are the same, share a common rotational shaft.

9. The apparatus according to claim 1, wherein:
the rotation mechanism includes a transmission which transmits a rotational force given by at least one of the pair of belt rollers to the plurality of supporting member.

10. The apparatus according to claim 1, further comprising:
a belt supporting roller for partially supporting the conveyor belt is positioned between the two supporting members whose positions in the conveyance direction are the same.

11. The apparatus according to claim 1, further comprising:
a platen positioned in a region surrounded by the plurality of the supporting members and the pair of belt rollers, wherein the platen has a plane extending over all the predetermined areas in the conveyance direction and supports the transfer belt by means of the plane.
